(19) United States
(12) Patent Application Publication
(10) Pub. No.: US 2009/0204577 A1
(43) Pub. Date: Aug. 13, 2009

(54) Saved Search and Quick Search Control

(75) Inventors: Dietrich Mayer-Ullmann, Ilwesheim (DE); Martin Schrepp, Hockenheim (DE); Theo Held, Wiesloch (DE); Kerstin Dittmar, Stuttgart (DE); Annett Hardt, Mannheim (DE); Susann Stieler, Heidelberg (DE); Ingo Deck, Mannheim (DE); Nadine Beigel, Bobenheim-Roxheim (DE)

Correspondence Address: BRAKE HUGHES BELLERMANN LLP, C/O CPA Global, P.O. BOX 52050, MINNEAPOLIS, MN, 55402, US

(73) Assignee: SAP AG, Walldorf (DE)

(21) Appl. No.: 12/028,635

(22) Filed: Feb. 8, 2008

(51) Int. Cl. G06F 7/00

(52) U.S. Cl. 707/3

(57) ABSTRACT

A computer-implemented method for facilitating a unified search comprising: providing a first user interface element with which a user can select a search type from a plurality of search types, wherein the search types comprise searches saved by a user and a plurality of standard searches; providing a second user interface element with which a user can select a refined search criteria that refines the selected search type; searching of customer relationship management data based upon the selected search type and the refined search criteria; and providing the results of the search in a single display frame.

### TECHNICAL FIELD

This description relates to customizing and managing a user interface for searching, and more specifically, to the customization and generation of a user interface for searching for data within a customer relationship system.

### BACKGROUND

Customer relationship management (CRM) is typically the practice of intelligently finding, marketing to, selling to, and servicing customers. Frequently, CRM includes the capture, storage, and analysis of information relating to customers, vendors, partners, and/or internal systems. Often a user may wish to search for specific information within the captured information.

### SUMMARY

According to one general aspect, a computer-implemented method for facilitating a unified search comprising: providing a first user interface element with which a user can select a search type from a plurality of search types, wherein the search types comprise searches saved by a user and a plurality of standard searches; providing a second user interface element with which a user can select a refined search criteria that refines the selected search type; searching of customer relationship management data based upon the selected search type and the refined search criteria; and providing the results of the search in a single display frame.

According to another general aspect, an apparatus comprising: a user interface generator configured to: provide a first user interface element configured to allow a user to select a search type from a plurality of search types, wherein the search types comprise searches saved by a user, and a plurality of generic searches, provide a second user interface element configured to allow a user to select a refined search criteria that refines the selected search type, and provide the results of a search in a single display frame; a search criteria manager configured to manage the plurality of search types and refined search criteria; and a search engine configured to search customer relationship management data based upon the selected search type and the refined search criteria

According to another general aspect, a machine readable medium comprising instructions capable of being executed by at least one machine, wherein the instructions, when executed, cause the machine to: providing a first user interface element with which a user can select a search type from a plurality of search types, wherein the search types comprise searches saved by a user and a plurality of standard searches; providing a second user interface element with which a user can select a refined search criteria that refines the selected search type; searching of customer relationship management data based upon the selected search type and the refined search criteria; and providing the results of the search in a single display frame.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example embodiment of a system in accordance with the disclosed subject matter.

FIG. 2 is a flow chart of an example embodiment of a technique in accordance with the disclosed subject matter.

FIG. 3 is a series of screen images of an example embodiment of a system in accordance with the disclosed subject matter.

### DETAILED DESCRIPTION

Typically, different types of computer or data searches, especially in the Customer Relationship Management (CRM) field, make use of different user interfaces. Generally within a customer relationship management system two or more searching user interfaces are employed.

The first searching user interface may include a set of predefined queries. These predefined queries are often set by the software manufacturer, or more often by the software administrator. Such predefined queries may include searches based upon fields in the CRM databases (e.g., name, client, contact, sales number, etc.). These predefined queries may be referred to as “Central Searches” in various CRM systems.

The second searching user interface may include a set of user defined searches. These searches are often originally created queries or refinements of predefined queries that have been saved by a user. These user defined queries may be referred to as “Saved Searches” in various CRM systems.

Currently, these two types of computer or data searches employ different user interfaces that may be accessed in different ways and function differently. For example, in various embodiments, predefined or generic searches may be initiated via a sidebar interface that is available as part of most screens in the CRM application. Conversely, the user defined or saved searches may only be available by navigating to a specific screen in the CRM application. The creation of a user defined search may occur on another screen, and a more complex search based upon multiple search criteria may involve yet another screen or interface. Likewise, the search results from each search may appear in different places or formats. Also, in some embodiments, the technique used to perform a search may differ from search type to search type. As a result, users may be frequently confused when searching for information. Actions that work within the predefined or generic search context may not work within the user defined or saved searches context, or vice versa, for example. The following disclosed subject matter may illustrate various embodiments that co-locate a plurality of search types and allow the plurality of search types to be performed using a relatively common user interface.

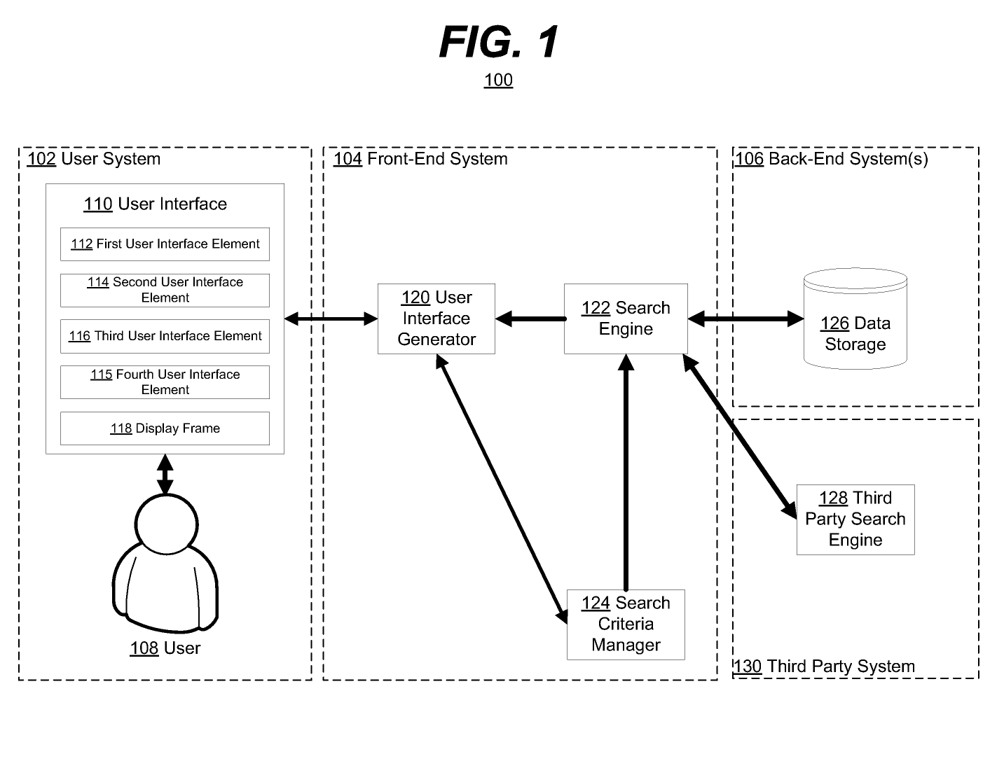

FIG. 1 is a block diagram of an example embodiment of a system 100 in accordance with the disclosed subject matter. In one embodiment, the system 100 may include a user system 102, a front-end system 104, and a back-end system 106. In some embodiments, the front-end system 104 may include a user interface generator 120, a search engine 122, and a search criteria manager 124.

In one embodiment, the user interface generator 120 may be configured to provide a first user interface element 112 configured to allow a user to select a search type from a plurality of search types. In various embodiments, the plurality of search types may include searches saved by a user 108 and a plurality of generic or predefined searches. In some embodiments, the generic searches may include searches preconfigured by a software designer, system administrator, or other privileged user of the front-end system 104.

In another embodiment, the generic searches may include search types such as, for example searches based upon particular fields in a database (e.g., data storage 126 of the back-end system 106); although, it is understood that the above is merely an illustrative example to which the disclosed subject matter is not limited. Examples of generic search types may include searches using data categories such as: accounts, activities, contacts, employee information, product information, etc. In addition to the generic searches, the user interface generator 120 may provide the ability to select searches saved by a user 108.

In one embodiment, the user interface generator 120 may be configured to provide a first user interface element 112 such that the search types are arranged in a hierarchal fashion. In various embodiments, the first user interface element 112 may include search types grouped by category in the top hierarchal level. Various categories may include categories that group generic search types based upon common characteristics. For example, a top level “Account” category may include generic search types in the lower hierarchal level such as Company, Last Name, First Name, Street, City, Postal Code, etc.; although, it is understood that the above are merely a few illustrative examples to which the disclosed subject matter is not limited. In one embodiment, these lower hierarchal level search types may map to fields within a database (e.g., data storage 126 of the back-end system 106).

In another embodiment, the user interface generator 120 may be configured to provide a first user interface element 112 using a drop-down label. In various embodiments, a label may be a static non-interactive user interface element that displays text or symbols on a user interface form. In many embodiments, a label is generally used to identify a nearby user interface element. In various embodiments, the text of the label may be selected or highlighted, but may not be modified by a user. In one embodiment, the user interface generator 120 may provide a drop-down label that, unlike traditional static labels, may effectively interact with a user.

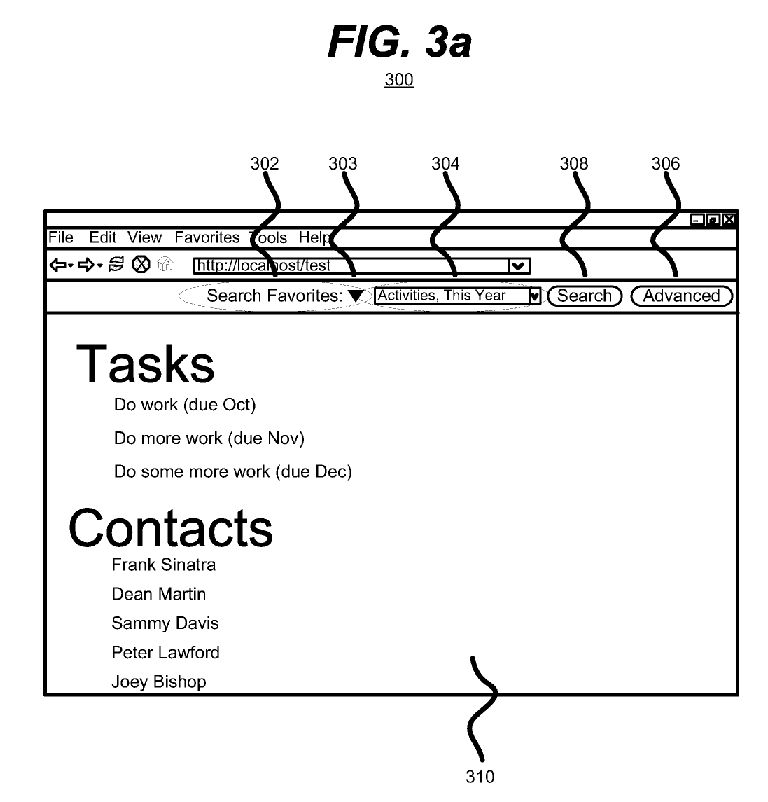

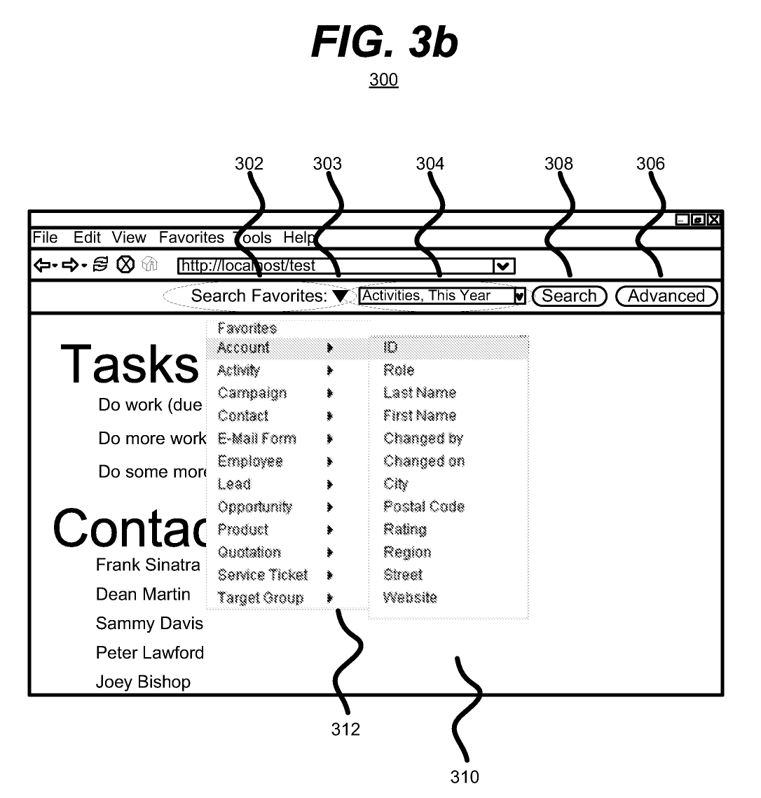

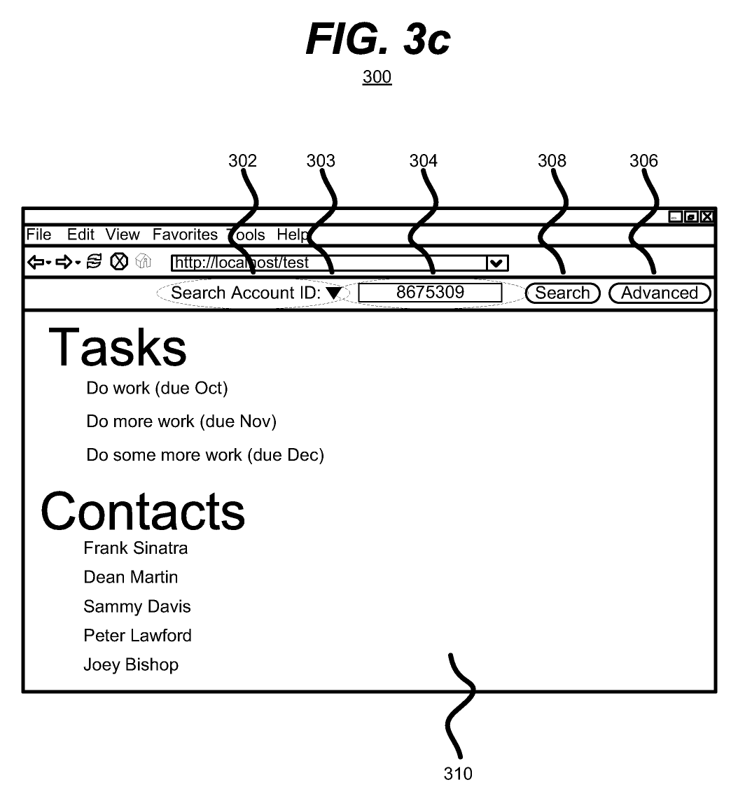

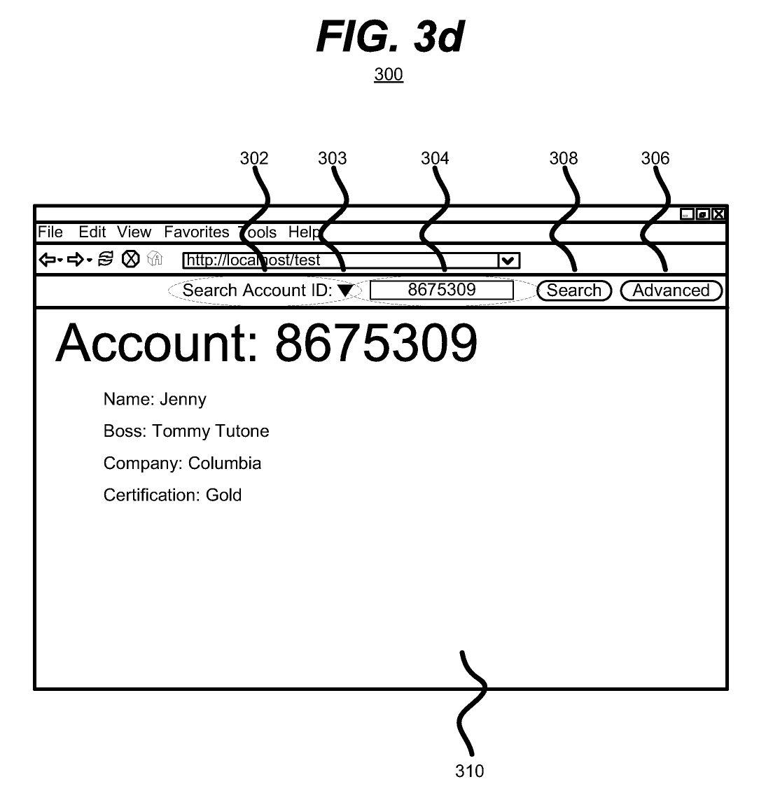

In such an embodiment, the user interface generator 120 may be configured to provide a drop-down label by creating a relatively standard label comprising the currently selected search type. In another embodiment, the user interface generator 120 may also be configured to create, with the text, an indicator that other search types may be selected. In various embodiments, the indicator may be a downward pointing triangle (as shown in FIG. 3 and described below).

The user interface generator 120 may be further configured to detect when the label is selected. In various embodiments, this may include detecting when the mouse hovers over the label or a region of the user interface 110 showing the label has been clicked by the mouse (or other pointing device, e.g., in embodiments with a touchscreen). In such an embodiment, the user interface generator 120 may be configured to create (e.g., drop-down) a menu associated with the label, wherein the menu comprises the plurality of search types. In some embodiments, the menu may replace the label. In various embodiments, a menu, in this context, may be a user interface element that provides the user with a list of choices. Typically, menus are associated with menubars or right-click actions. In one embodiment, the user interface generator 120 may be configured to associate the menu with the label. In various embodiments, once the user has selected one of the plurality of search types the user interface generator 120 may change or replace the label with a new label displaying the selected search type.

In one embodiment, the user interface generator 120 may be configured to provide a second user interface element 114 to allow or with which a user may select a refined search criteria that refines the selected search type. For example, in one embodiment, the user may select the “Account Number” search type using the first user interface 112. In such an embodiment, the second user interface element 114 may be a text box in which a user may enter an account number. In this context, a text box may be a (typically) rectangular box that provides an area for a user to input text. In various embodiments, the text box may include a single line or multiple lines. In another example embodiment, the second user interface 114 may include a drop-down list that allows a user to select from a limited number of options. For example, in one embodiment, the user may select the “Account Number” search type using the first user interface 112. In such an embodiment, the second user interface element 114 may be a list of all possible account numbers. In one embodiment, the user generator 120 may provide or replace the form of the second user interface element 114 based upon the selected search type. Possible user elements may include, but are not limited to, text boxes, check boxes, combo-boxes, drop-down lists, drop-down labels, etc. Although, it is understood that the above are merely a few illustrative examples to which the disclosed subject matter is not limited.

In one embodiment, one of the search types may be searches saved by the user or a group of users that includes the current user. In such an embodiment, when the selected search type is the saved searches, the second user interface element 114 may display a list of the saved searches. Such searches may include, but are not limited to, search such as, “My Clients”, “My Accounts”, “My Employees”, “January Sales”, “Revenue from Joe”, etc.; although, it is understood that the above are merely a few illustrative examples to which the disclosed subject matter is not limited. In one embodiment, the user interface generator 120 may provide a drop-down list as the second user interface element 114 allowing the user to refine the saved search they wish to use. In such an embodiment, if the refined search requires additional refinement (e.g., a date range) the user interface generator 120 may replace the drop-down list with a text box or other user interface element to allow the user to input yet more refining search criteria. Alternatively, in yet another embodiment, saved searches requiring additional user input may be provided via the first user interface element 112 as part of a second tier in the hierarchy of selectable search types and the second user interface element 114 may provide the ability to refine the selected saved search by inputting the additional information. Although, it is understood that the above are merely a few illustrative examples to which the disclosed subject matter is not limited.

In various embodiments, once the user has selected a search type and a refined search criteria, via the first user interface element 112 and second user interface elements 114, respectively, the user may initiate a search. In various embodiments, the search may be initiated by selecting a fourth user interface element 115, typing “Enter” into the second user interface element 114, by otherwise refining the search criteria, or another technique. In such an embodiment, the search engine 122 of the front-end system 104 may be configured to search customer relationship management (CRM) data 126 based upon the refined search criteria. In various embodiments, the CRM data 126 may be included within one or more back-end systems 106, the front-end system 104, or the user system 102.

In one embodiment, the user interface generator 120 may be configured to provide the search results in a single display frame 118. In various embodiments, the single display frame 118 may be configured to include search results from either the plurality of generic search types or the user defined saved search types, as described above. Using such a single display frame 118 to show the results pertaining to any of the search types (e.g., generic or saved) may allow increased efficiently to and understanding by a user. This is contrasted with a system that may use multiple display frames to display or execute searches, wherein each search type or group of search types (e.g., generic or saved) may use different display frames. Such a system may lead to inefficiencies and confuse the user, as the user must switch between display frames to get the desired results.

In some embodiments, the display frame 118 may include the first user interface element 112, second user interface element 114, the third user interface element 116, and the fourth user interface element 115. In one embodiment, the user interface generator 120 may be configured to provide the user interface elements as part of the display frame 118.

In some embodiments, the search engine 122 may be configured to utilize a third-party search engine 128. In another embodiment, the third party search engine 128 may be included within a third-party system 130, a back-end system 106, or the front-end system 104. In some embodiments, the third party search engine 128 may even be included within the user system 102. For example, the third party search engine 128 may be a desktop search engine that allows for the searching of data on the user system 102. The search engine 122 may be configured to interact with or forward the search to the third-party search engine 128 and display the results of the search in the display frame 118 as if or in a similar fashion to searches performed by the search engine 122. In various embodiments, the third-party search engine 130 may include Internet or web search engines (e.g., Yahoo™, Google™, etc.), subscription based search engines (e.g., LexisNexis™, etc.), a proprietary search engine (e.g., the TREX search engine from SAP™, etc.), or another type of search engine; although, it is understood that the above are merely a few illustrative examples to which the disclosed subject matter is not limited.

In one embodiment, the user interface generator 120 may be configured to provide an interface for a user to create and save a search. In some embodiments, the user interface generator 120 may provide the interface as part of the single display frame 118. In one embodiment, the user interface generator 120 may be configured to provide a third user interface element 116 with which the user may save a search. In one embodiment, the third user interface element 116 may allow the user to save the current search.

In another embodiment, the user interface generator 120 may be configured to display a plurality of configurable search criteria within the single display frame 118. The user may then create a customized search based upon the configurable search criteria. Such searches may include, but are not limited to, search such as, “My Clients”, “My Accounts”, “My Employees”, “January Sales”, “Revenue from Joe”, etc.; although, it is understood that the above are merely a few illustrative examples to which the disclosed subject matter is not limited. In one embodiment, the saved search may be added to the search types (selectable via the first user interface element 112) or the refined search criteria that are associated with the “Saved Searches” search type (selectable via the second user interface element 114).

In one embodiment, the search criteria manager 124 may be configured to manage the plurality of search types and the refined search criteria. In various embodiments, the search criteria manager 124 may be configured to add the saved search, as described above, to either the plurality of search types or the refined search criteria. In another embodiment, the search criteria manager 124 may be configured to arrange the plurality of search types into a hierarchal structure. The user interface generator 120 may display this hierarchal structure within the first user interface element 112, as described above.

In one embodiment, the system 100 may be configured to allow complex searches using a plurality of search criteria; as opposed to a search based upon a search type and one or a few refining search criteria. In such an embodiment, the user interface generator 120 may be configured to provide for the display of a plurality of selectable search criteria in the single display frame 118. A user 108 may then select a subset of the selectable search criteria and request that a search be performed using the selected search criteria. In one embodiment, the search engine 122 may be configured to perform a search of the customer relationship management data based upon the selected search criteria. The user interface generator 120 may be further configured to replace the displayed selectable search criteria with the results of the search.

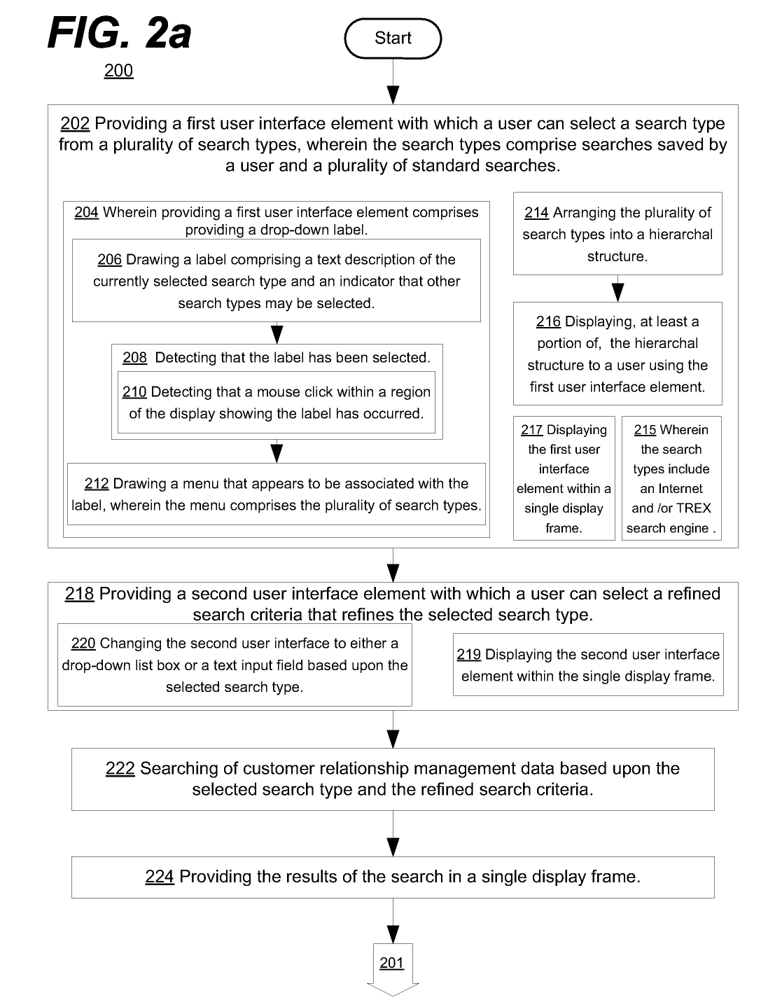

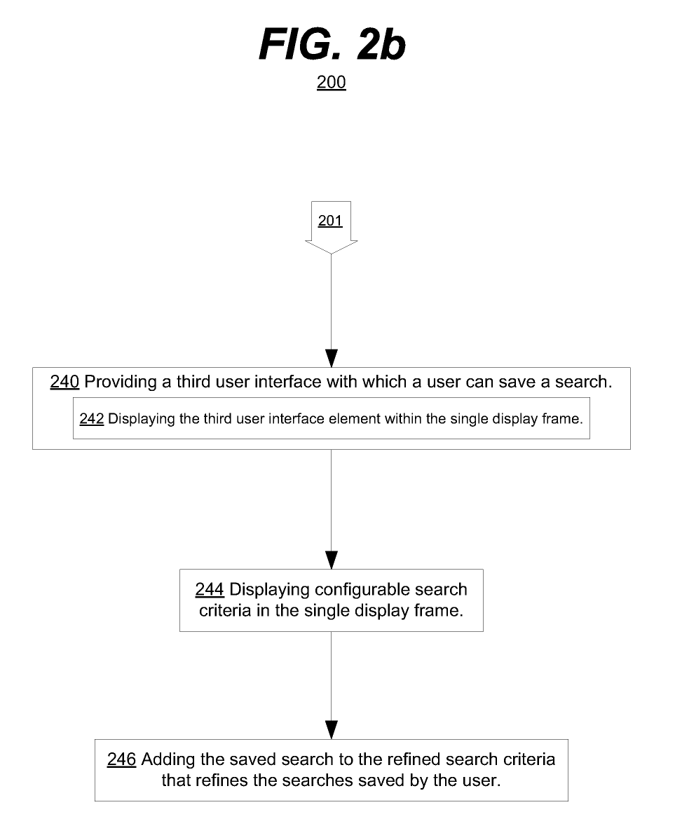

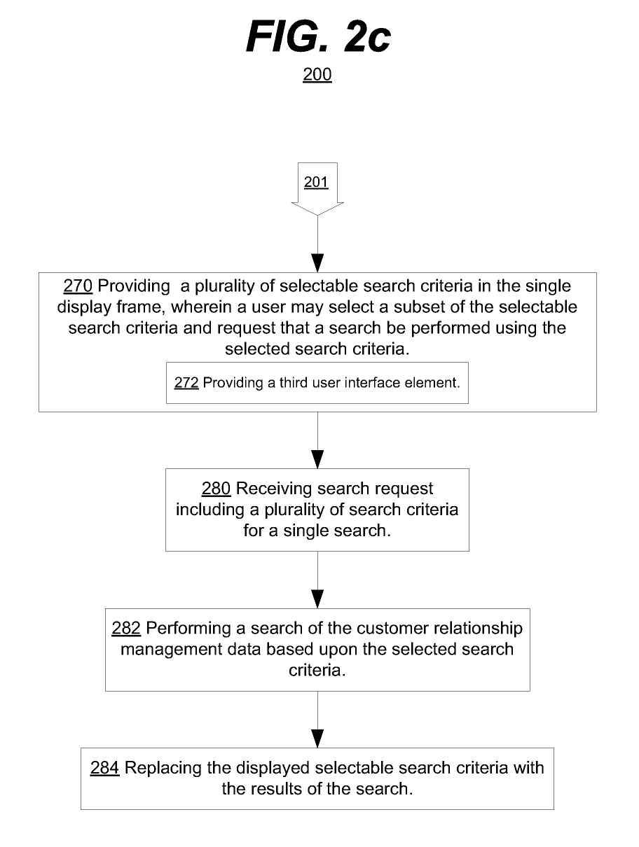

FIG. 2 is a flow chart of an example embodiment of a technique 200 in accordance with the disclosed subject matter. It is understood that FIGS. 2a, 2b, and 2c represent a single flowchart illustrated on three pages. The connector 201 provides a way to represent the connection between the pages. Hereafter and here-before, the flowchart of the technique 200 is simply referred to as FIG. 2, as if the flowchart merely occupied a single page. It is also understood that FIGS. 2b and 2c provide further enhancements or features of technique 200. As such the actions illustrated by FIGS. 2b and 2c are not mutually exclusive and, in one embodiment, may occur in parallel or, in another embodiment, in series.

Block 202 illustrates that, in one embodiment, a first user interface element may be provided with which a user can select a search type from a plurality of search types. In various embodiments, the search types may comprise searches saved by a user, and a plurality of standard searches. In some embodiments, the user interface generator 120 of FIG. 1, may provide the first user interface element, as described above.

Block 204 illustrates that, in one embodiment, a first user interface element maybe a drop-down label. In various embodiments, as illustrated by Block 206 providing the drop-down label may include drawing a label comprising the currently selected search type and, in some embodiments, an indicator that other search types may be selected. In some embodiments, the user interface generator 120 of FIG. 1, may draw the label and indicator, as described above.

Block 208 illustrates that, in one embodiment, providing the drop-down label may include detecting that the label has been selected. Block 210 illustrates that, in some embodiments, providing the drop-down label may include detecting that a mouse click within a region of the display showing the label has occurred; although it is understood that the term “mouse” in this context may include any pointing device (e.g., a trackball, pen, touchscreen, mouse, etc.). In some embodiments, the user interface generator 120 of FIG. 1, may perform this detection, as described above.

Block 212 illustrates that, in one embodiment, providing the drop-down label may include drawing a menu that appears to be associated with the label. In various embodiments, the menu may include the plurality of search types. In some embodiments, the user interface generator 120 of FIG. 1, may provide or draw the menu, as described above.

Block 214 illustrates that, in one embodiment, providing the first user interface element may include arranging the plurality of search types into a hierarchal structure. In some embodiments, the user interface generator 120 or the search criteria manager 124 of FIG. 1, may arrange the search types, as described above.

Block 216 illustrates that, in one embodiment, providing the first user interface element may include displaying, at least a portion of, the hierarchal structure to a user using the first user interface element. In various embodiments, displaying the structure may include using a series of cascading menus. In some embodiments, the user interface generator 120 of FIG. 1, may arrange the search types, as described above.

Block 215 illustrates that, in one embodiment, the plurality of search types may include third party search engines. In various embodiments, the third party search engines may include Internet or web search engines (e.g., Yahoo™, Google™, etc.), subscription based search engines (e.g., LexisNexis™, etc.), a proprietary search engine (e.g., the TREX search engine from SAP™M, etc.), or another type of search engine; although, it is understood that the above are merely a few illustrative examples to which the disclosed subject matter is not limited. In some embodiments, the user interface generator 120 of FIG. 1, may provide these search engines as a search type selectable via the first user interface element, as described above.

Block 217 illustrates that, in one embodiment, providing the first user interface element may include displaying the first user interface within a single display frame. In various embodiments, the single display frame may be the same display frame that is used to display the results of the search, as described below in reference to Block 224. In some embodiments, the user interface generator 120 of FIG. 1, may display the first user interface element, as described above.

Block 218 illustrates that, in one embodiment, a second user interface element may be provided with which a user can select a refined search criteria that refines the selected search type. In various embodiments, the refined search criteria may change based upon the selected search type. In some embodiments, the user interface generator 120 of FIG. 1, may display the second user interface element, as described above.

Block 219 illustrates that, in one embodiment, the second user interface element may be displayed within the single display frame. In various embodiments, this single display frame may be the display frame used to display the results of the search as described below in reference to Block 224. In some embodiments, the user interface generator 120 of FIG. 1, may display the second user interface element, as described above.

Block 220 illustrates that, in one embodiment, providing the second user interface element may include changing the second user interface element to a given user element based upon the selected search type. Possible user element forms may include, but are not limited to, text boxes, check boxes, combo-boxes, drop-down lists, drop-down labels, etc. Although, it is understood that the above are merely a few illustrative examples to which the disclosed subject matter is not limited. In some embodiments, the user interface generator 120 of FIG. 1, may change the second user interface element, as described above.

Block 222 illustrates that, in one embodiment, customer relationship management data may be searched based upon the selected search type and the refined search criteria. In one embodiment, the search may be performed using a third-party search engine, as described above. In some embodiments, the search engine 122 of FIG. 1, may perform or manage the search, as described above.

Block 224 illustrates that, in one embodiment, the results of the search may be provided within a single display frame. In some embodiments, the user interface generator 120 of FIG. 1, may provide the search results, as described above. In some embodiments, the display frame 118 of FIG. 1, may be used to display the search results.

Block 240 illustrates that, in one embodiment, a third user interface element may be provided with which a user may save a search. Block 242 illustrates that, in one embodiment, a third user interface element may be included within the single display frame, as described above in reference to Block 242. In some embodiments, the user interface generator 120 of FIG. 1, may provide the third user interface element, as described above.

Block 244 illustrates that, in one embodiment, configurable search criteria may be displayed within the single display frame, as described above. In various embodiments, the configurable search criteria may allow a user to arrange or configure a one or more of the search criteria into a user defined search. In some embodiments, the user interface generator 120 of FIG. 1, may display the configurable search criteria, as described above.

Block 246 illustrates that, in one embodiment, the saved search may be added to or saved as part of the “searches saved by a user” search type. In one embodiment, the search may be added as a refining search criteria displayed by the second user interface element. In another embodiment, the search may be added as a lower tier hierarchal item within the “searches saved by a user” search type and criteria displayed by the first user interface element. It is understood that the term “searches saved by a user” is not a restrictive phrase that dictates the name of the search type, but merely a colloquial definition to which the disclosed subject matter is not limited. In some embodiments, the user interface generator 120 or the search criteria manager 124 of FIG. 1, may manage the saved searches, as described above.

Block 270 illustrates that, in one embodiment, a plurality of selectable search criteria may be provided or displayed in the single display frame. In various embodiments, a user may select a subset of the selectable search criteria and request that a search be performed using the selected search criteria, as described above. In some embodiments, the user interface generator 120 of FIG. 1, may provide the selectable search criteria, as described above.

Block 272 illustrates that, in one embodiment, a third user interface element may be provided that initiates the providing of the selectable search criteria. In various embodiments, a third user interface element may be provided that may facilities the actions illustrated by both Block 272 and Block 240. In some embodiments, the user interface generator 120 of FIG. 1, may provide the third user interface element, as described above.

Block 280 illustrates that, in one embodiment, a plurality of search criteria for a single search may be received. In various embodiments, a user may have initiated a search request by selecting the third user interface element or another (e.g., a fourth) user interface element. In some embodiments, the search engine 122 of FIG. 1, may receive the search request including the plurality of search criteria, as described above.

Block 282 illustrates that, in one embodiment, a search of the customer relationship management data, based upon the selected search criteria, may be performed, as described above. In some embodiments, the search engine 122 or the third-party search engine 128 of FIG. 1, perform the search, as described above.

Block 284 illustrates that, in one embodiment, the displayed selectable search criteria may be replaced with the results of the search. In such an embodiment, the results of the search may be displayed within or included in the single display frame, as described above. In some embodiments, the user interface generator 120 of FIG. 1, may replace the search criteria, as described above.

FIG. 3 is a series of screen images of an example embodiment of a system 300 in accordance with the disclosed subject matter. In one embodiment, the system or user interface 300 may include a first user interface element 302, a second user interface element 304, a third user interface element 306, a fourth user interface element 308, and a display frame 310.

FIG. 3a is a screen image of an example embodiment of a system 300 in accordance with the disclosed subject matter. In such an illustrative embodiment, the system 300 of FIG. 3a may be in the default state. In such a situation, the display frame 310 may show a set of default information (e.g., a series of tasks and contacts are illustrated).

In various embodiments, the first user interface element 302 may display a default value, default search type, or the previously selected search type. In the illustrated embodiment, the first user interface element 302 may include a label that displays the text “Search Favorites”, that denotes that the user saved searches search type is selected; although, it is understood that the above are merely a few illustrative examples to which the disclosed subject matter is not limited. In this embodiment, the first user interface element 302 may include a drop-down label that comprises a label and an indicator 303 that denotes that the other search types may be selected.

In some embodiments, the second user interface element 304 may display a default value, default search type, or the previously refining search criteria. In the illustrated embodiment, the second user interface element 304 may include a drop-down list that displays the text “Activities, This Year”, that implies that the search would return all activities from the current year; although, it is understood that the above are merely a few illustrative examples to which the disclosed subject matter is not limited.

In one embodiment, for example, the third user interface element 306 may include a button or, in another embodiment, a combutcon. In this context a combutcon may be a user interface element that integrates a button and a popup menu. A combutcon may include of a primary button, that typically initiates an operation or command when selected, and a menu button, that typically launches a popup menu when selected. It is understood that the term “combutcon” is a combination of the words “combined”, “button”, and “icon”. In various embodiments, the third user interface element 306 may be used to either save a search or, in an alternate mode, search using a plurality of selectable search criteria, as described above. In the embodiments using a combutcon, the popup menu may facilitate the selection between the two modes; although, it is understood that the above are merely a few illustrative examples to which the disclosed subject matter is not limited.

In one embodiment, the fourth user interface element 308 may include, for example, a button. In various embodiments, when the fourth user interface element 308 is selected a search may be initiated. In some embodiments, the initiation may include sending a search request, including the selected search type and/or refining search criteria to a search engine.

FIG. 3b is a screen image of an example embodiment of a system 300 in accordance with the disclosed subject matter. In such an illustrative embodiment, the system 300 of FIG. 3b may show the system 300 after the first user interface element 302 has been selected.

In such an embodiment, a user may wish to select a new search type. The user may select the first user interface element 302. In embodiments using a drop-down label, a menu 312 may be displayed that is associated with the label of the first user interface element 302. The first user interface element 302 may display the plurality of search types that include the saved searches (e.g., “Favorites”) and a number of generic or predefined search types (e.g., “Account”, “Activity”, “Contact”, etc.). The first user interface element 302 may display the plurality of search types in a hierarchal fashion such that the types are grouped using some scheme or technique. For example, in the illustrated embodiment, the sub-type “ID” may be selected from the larger “Account” search type. As such, the search type “Account ID” may become the selected search type.

FIG. 3c is a screen image of an example embodiment of a system 300 in accordance with the disclosed subject matter. In such an illustrative embodiment, the system 300 of FIG. 3c may show the system 300 after a new search type has been selected. In one embodiment, the menu of the first user interface element 302 may be removed or closed, and the text of the first user interface element 302 may be replaced with the newly selected search type (e.g., “Account ID”). The second user interface element 304 may, in various embodiments, be changed from one user interface element to another. For example, in the illustrated embodiment, the drop-down list of FIGS. 3a and 3b may be changed to a text box of FIG. 3c; although, it is understood that the above is merely one illustrative example to which the disclosed subject matter is not limited. The user may input or type a refining search criteria (e.g., “8675309”) into or via the second user interface element 304. The user may then initiate the search by selecting the fourth user interface element 308.

FIG. 3d is a screen image of an example embodiment of a system 300 in accordance with the disclosed subject matter. In such an illustrative embodiment, the system 300 of FIG. 3d may show a system 300 after the results of the search have been displayed. In one embodiment, the display frame 310 may display the results of the search. In various embodiments, if additional searches are run, using either new search types or refining search criteria the results of those searches may be displayed within the display frame 310.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for facilitating a unified search comprising:
providing a first user interface element with which a user can select a search type from a plurality of search types, wherein the search types comprise searches saved by a user and a plurality of standard searches;
providing a second user interface element with which a user can select a refined search criteria that refines the selected search type;
searching of customer relationship management data based upon the selected search type and the refined search criteria; and
providing the results of the search in a single display frame.

2. The method of claim 1 wherein providing a first user interface element comprises providing a drop-down label.

3. The method of claim 2 wherein providing the drop-down label comprises:
drawing a label comprising a text description of the currently selected search type and an indicator that other search types may be selected;
detecting that the label has been selected; and
drawing a menu associated with the label, wherein the menu comprises the plurality of search types.

4. The method of claim 3 wherein detecting that the label has been selected comprises detecting that a pointing device event, within a region of the display frame showing the label, has occurred.

5. The method of claim 1 wherein providing a second user interface element comprises:
changing the second user interface to either a drop-down list box or a text input field based upon the selected search type.

6. The method of claim 1 wherein providing a first user interface element with which a user can select a search type comprises:
arranging the plurality of search types into a hierarchal structure; and
displaying, at least a portion of, the hierarchal structure to a user using the first user interface element.

7. The method of claim 1 wherein providing a first user interface element comprises displaying the first user interface element within the single display frame; and
wherein providing a second user interface element comprises displaying the second user interface element within the single display frame.

8. The method of claim 1 further comprising:
providing a third user interface with which a user can save a search;
displaying configurable search criteria in the single display frame; and
adding the saved search to the refined search criteria that refines the searches saved by the user.

9. The method of claim 1 further comprising:
providing a plurality of selectable search criteria in the single display frame, wherein a user may select a subset of the selectable search criteria and request that a search be performed using the selected search criteria;
receiving search request including a plurality of search criteria for a single search;
performing a search of the customer relationship management data based upon the selected search criteria; and
replacing the displayed selectable search criteria with the results of the search.

10. An apparatus comprising:
a user interface generator configured to:
provide a first user interface element configured to allow a user to select a search type from a plurality of search types, wherein the search types comprise searches saved by a user, and a plurality of generic searches,
provide a second user interface element configured to allow a user to select a refined search criteria that refines the selected search type, and
provide the results of a search in a single display frame;
a search criteria manager configured to manage the plurality of search types and refined search criteria; and
a search engine configured to search customer relationship management data based upon the selected search type and the refined search criteria.

11. The apparatus of claim 10 wherein the first user interface element comprises a drop-down label.

12. The apparatus of claim 11 wherein the user interface generator is further configured to:
create a label comprising a text description of the currently selected search type and an indicator that other search types may be selected;
detect the selection of the label; and
create a menu associated with the label, wherein the menu comprises the plurality of search types.

13. The apparatus of claim 12 wherein the user interface generator is configured to detect the selection of the label by the detection of a pointing device click, within a region of the display frame showing the label.

14. The apparatus of claim 10 wherein the a search criteria manager is configured to arrange the plurality of search types into a hierarchal structure; and
wherein the user interface generator is configured to provide at least a portion of the hierarchal structure to a user using the first user interface element.

15. The apparatus of claim 10 wherein the user interface generator is configured to provide the first user interface element and the second user interface element within the single display frame.

16. The apparatus of claim 10 wherein the search types further comprise searches utilizing a third-party search engine; and
wherein the search engine is configured to, when a third-party search engine is selected as the selected search type:
transmit a request to perform a search to a third-party search engine, and
receive the results of the search from the third-party search engine.

17. The apparatus of claim 10,
wherein the user interface generator is configured to provide an interface, within the single display frame, for a user to create and save a search; and
wherein the search criteria manager is configured to add the saved search to the refined search criteria that refines the searches saved by the user.

18. The apparatus of claim 10 wherein the user interface generator is configured to:
provide for the display of a plurality of selectable search criteria in the single display frame, wherein a user may select a subset of the selectable search criertia and request that a search be performed using the selected search criteria,
replace the displayed selectable search criteria with the results of the search; and
wherein the search engine is configured to perform the search of the customer relationship management data based upon the selected search criteria.

19. A machine readable medium comprising instructions capable of being executed by at least one machine, wherein the instructions, when executed, cause the machine to:
providing a first user interface element with which a user can select a search type from a plurality of search types, wherein the search types comprise searches saved by a user and a plurality of standard searches;
providing a second user interface element with which a user can select a refined search criteria that refines the selected search type;
searching of customer relationship management data based upon the selected search type and the refined search criteria; and
providing the results of the search in a single display frame.

20. The machine readable medium of claim 19 wherein the instructions for providing a first user interface element include instructions for providing a drop-down label.
